(19) United States
(12) Patent Application Publication
(10) Pub. No.: US 2022/0369850 A1
(43) Pub. Date: Nov. 24, 2022

(54) Method and Appliance for Producing Beverages, Preferably Foamed Milk or Milk Beverages

(71) Applicant: STEINER AG WEGGIS, Weggis (CH)

(72) Inventor: Adrian Steiner, Weggis (CH)

(73) Assignee: STEINER AG WEGGIS, Weggis (CH)

(21) Appl. No.: 17/753,991

(22) PCT Filed: Sep. 10, 2020
(86) PCT No.: PCT/EP20/75370

§ 371 Date: Mar. 21, 2022

(30) Foreign Application Priority Data
Oct. 14, 2019 (CH) 01308/19

(51) Int. Cl. A47J 31/44; A47J 31/46; A23L 2/54

(52) U.S. Cl. CPC A47J 31/4485; A47J 31/461; A23L 2/54; A23V 2002/00

(57) ABSTRACT

Method for producing beverages, preferably foamed milk or milk beverages, in which milk is sucked up out of a container by a pump through at least one line and is conveyed through the latter to an outlet. Preferably, multiple different flavor liquids can be supplied as desired from a respective vessel at least individually into the line for conveying the milk. In this manner, the flavor liquid is mixed in already during production of the milk beverage, with the result that a high degree of mixing and thus the desired flavor is optimally achieved.

### FIELD OF THE INVENTION

The invention relates to a method for producing beverages, preferably foamed milk or milk beverages, with which milk is sucked out of a container by means of a pump through at least one line, and is conveyed through this line to an outlet. The present invention is also related to an appliance that performs the method and is integrated in a coffee machine or in a separate milk unit.

### BACKGROUND OF THE INVENTION

With known coffee machines of this type, the milk sucked out of the container is processed in a cold or hot state, or processed to form cold or hot foamed milk, and then discharged into a cup or the like. In addition, flavor liquids can be added to the beverage which has been produced, in that they are held in a replaceable manner in or next to the coffee machine, and are conveyed through hoses to an outlet next to the milk outlet and into the cup or the like. There they are mixed into the beverage in a cup or the like. This, however, does not provide a uniform and thoroughly mixed beverage.

The flavor liquids which are mixed in are usually syrups with an aroma of vanilla, chocolate, fruits such as raspberry, strawberry, or similar substances. It is also possible, however, for alcoholic flavor liquids to be used, such as for Irish Coffee or the like.

### OBJECTS AND SUMMARY OF THE INVENTION

The invention is based on the object of avoiding these disadvantages, and providing a method and apparatus of the type referred to in the preamble, by means of which the preparation of aromatized milk beverages is simplified, and in this situation an optimum mixing of the flavor liquid in the beverage is guaranteed.

The object is solved according to the invention in that, preferably, multiple different flavor liquids can be supplied as desired from a respective vessel, at least individually, through at least one feed line into the line for conveying the milk.

In this way, the mixing of the flavor liquid takes place already at the production of the milk beverage in the appliance, which is integrated in a coffee machine or a separate milk unit, the consequence of which is that a high degree of mixing and thus the desired flavor is optimally achieved.

Advantageously, the flavor liquid is added to the milk upstream of the inlet opening of the air delivery line into the milk conveying line. It is therefore possible, with this arrangement, for uniform milk beverages, with or without foamed milk, to be optimally mixed with the desired flavor.

With the use of a steam line as a heating device for the milk, opening into the milk conveying line, the invention makes provision for the flavor liquid to be added to the beverage upstream of the inlet opening of the steam line into the milk conveying line, and this is therefore also optimally achieved, since in this way the flavor liquid is likewise heated, or, if cold milk or cold foamed milk is being produced, it remains in a cold state.

As an alternative, however, provision can be made for the flavor liquid to be added to the beverage downstream of the inlet opening of the steam line in the milk conveying line, but upstream of the outlet of the beverage out of the coffee machine. This could be advantageous in order to achieve a foamed milk of better consistency.

The invention likewise makes provision for the coffee machine to be provided with preferably four different flavor liquid vessels, which can be connected via a common connection part to the milk conveying line, with four inlets and with a non-return valve preventing the flow of milk or foamed milk into the vessels. By selective opening and closing of the inlets, the beverage can be provided with the respective flavor.

As a further advantage, the method according to the invention makes provision for the flavor liquid, if required, also to be conveyed without milk through the milk conveying line into the cup or the like, in order for it to be conveyed separately to the beverage which has already been produced, such as to allow for a decorative figure to be produced on the surface of the foamed milk.

### BRIEF DESCRIPTION OF THE DRAWINGS

The invention is described in greater detail hereinafter on the basis of exemplary embodiments, making reference to the drawings, wherein:

FIG. 1 is a hydraulic schematic of an appliance according to the invention, and

FIG. 2 is a perspective view of a connection sleeve at the inlet of the flavor liquid into the milk conveying line of the appliance according to FIG. 1.

### DETAILED DESCRIPTION OF THE INVENTION

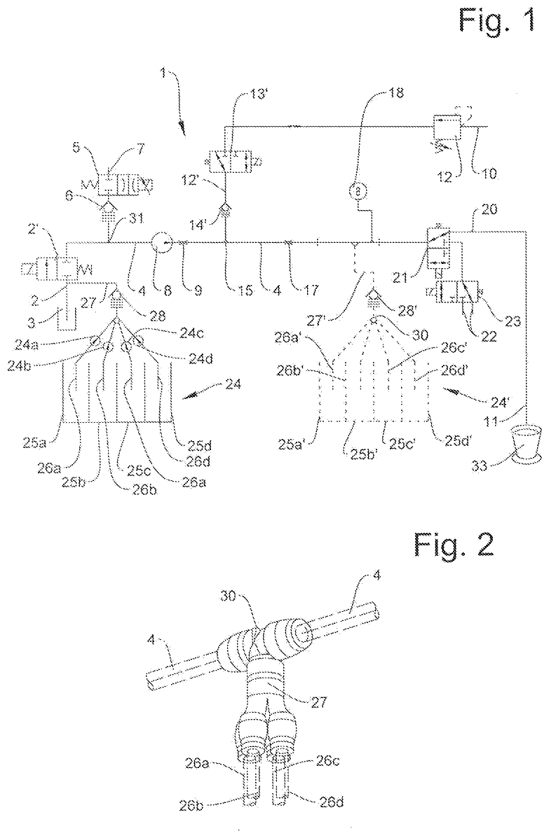

The appliance shown in FIG. 1 contains a milk container 3, with a line 2, which can be connected, as a suction hose with a two-way valve 2′, to the line 4. The milk container 3 could also consist of several part containers with different types of milk. In principle, this two-way valve 2′ could be provided with a through-hole choke, such that, regardless of the filling level in the container 3, approximately the same quantity of milk would be sucked up.

The appliance 1 also contains an air supply line 7, which can be connected to the intake opening 31 of the line 4 via a switchable control valve 5 and a non-return valve 6 for preparing the foamed milk. In addition, a controllable pump 8 is arranged in the line 4, with which the milk is sucked out of the milk container 3 and is conveyed to an outlet 11. Located in the line 4 downstream of the pump 8, configured, for example, as a gear pump, are preferably two choke points 9, 17, in order to achieve a swirling effect on the milk or the milk/air mixture.

Following this is a heating device for heating the milk or the foamed milk, which consists of a steam delivery line 10 with a pressure equalizing valve 12, and, following this, at least one steam line 12′, which opens into the line 4 via a slide valve or opening valve 13′ and a non-return valve 14′. Downstream of its inlet opening 15, the line 4 contains a further choke 17 for slowing or swirling the milk or foamed milk, which is provided optionally.

At the line 4, an outlet line 20 connects to an outlet 11 for the milk beverage which has been produced, for filling a cup 33 or the like. A two-way valve 21 serves, on the one hand, to let the milk or foamed milk through to the outlet 11, and, on the other hand, interacts with a conventional cleaning circuit, of which a feed line and discharge line 22 are shown, with a cleaning valve 23 which can be switched on or off.

In addition, at least one thermostat 18 is integrated in the line 4 for measuring the temperature of the milk or foamed milk. With this, by means of a regulating arrangement, a controlled production of foamed milk can be achieved in a known manner, which is not explained in any greater detail. In principle, it would also be possible for a measuring device to be integrated in the line 4, in order to determine the consistency of the foamed milk which is to be prepared.

According to the invention, a feed device 24 is contained in the appliance 1, in particular for producing aromatized milk beverages from several vessels 25a to 25d, which during operation are filled with flavor liquids. In each vessel is a flavor liquid, each with a different aroma or all with the same aroma.

With the exemplary embodiment described, the device is provided with four vessels. Within the framework of the invention, it is also possible, however, depending on the requirement, for fewer or more than four vessels to be provided. These vessels are advantageously located in an exchangeable manner in the device 1, such that, after emptying, they can be replaced with new vessels

As has already been mentioned heretofore, suitable as flavor liquids are, in particular, syrups with an aroma of vanilla, chocolate, fruits such as raspberries, strawberries, bananas, or similar substances, or also alcoholic flavor liquids.

The liquids in the vessels 25a to 25d can be selectively sucked up and conveyed by means of individual lines 26a to 26d, by the pump 8 and/or each by way of conveying means 24a, 24b, 24c, 24d into the common feed line 27, with a non-return valve 28, directly into the line 2, in which the respective flavor liquid which has been selected is mixed with the milk. The inlet opening of the feed line 27 into the line 2 is located between the milk container 3 and the two-way valve 2′, i.e., upstream of the pump 8 sucking the milk, and upstream of the inlet opening 31 of the air feed line 7. In this way, as desired, either milk or foamed milk beverages are produced with the flavor of the flavor liquid which has been selected.

These conveying means 24a, 24b, 24c, 24d can also simply be controllable valves, of which one or more would open when the respective flavor liquid is introduced, such that the liquid would be sucked up by the pump 8.

Moreover, shown in FIG. 1 is also an appliance 24′, represented by a broken line, which could be provided instead of or in addition to the appliance 24. With this, the connection into the line 4 is placed downstream of the connection 15 of the steam line 12′. To connect the vessels 25a′ to 25d′ into the line 4, a feed line 27′ with a non-return valve 28′ is provided.

These appliances 24 and 24′ provide the same advantages in respect of the possibility of producing both cold as well as hot aromatized milk and foamed milk beverages. Only the degree of mixing between the milk or foamed milk and the flavor liquid which has been selected in the respective case can vary somewhat if appropriate.

The appliance 24, 24′ according to the invention, which can be integrated in a coffee machine or in a separate unit, is characterized by a very compact structural form, which allows for a selective choice to be made by selection buttons on the operating display. It also has the advantage that it hardly influences the overall structure of the appliance as far as the outlet.

FIG. 2 further shows another variant of a connection sleeve 30 of the feed appliance 24, which connects the lines 25a to 25d and the feed line 27 into the line 4. Such a connection can therefore be installed very easily.

The invention is adequately described by the exemplary embodiments explained heretofore. It may also be explained by further variants. For example, instead of the one feed line 27 leading into the milk line, it would also be possible for each line 26a, 26b, 26c, 26d to lead directly into this milk line.

Instead of the conveying means 24a, 24b, 24c, 24d, which also have the effect of a closure valve, it would be possible, as mentioned, for closure valves to be provided, such that, when selecting a specific flavor liquid, the corresponding closure valve is opened and the specific single conveying means is switched on, and therefore the corresponding flavor liquid would be conveyed into the milk line. It would also be possible for more than one flavor liquid to be introduced simultaneously.

It would also be possible for a flow-type heater or the like to be provided as the heating appliance, which would be integrated in a known manner in the line 4 of the milk conveying system.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. Method for producing beverages, preferably foamed milk or milk beverages, with which milk is sucked up out of a container by means of a pump through at least line and conveyed through this to an outlet, the method comprising independently supplying multiple different flavor liquids as desired from a respective container at least individually into the line for conveying the milk.

2. Method according to claim 1, wherein the at least one flavor liquid is sucked up from the container by the pump and/or via a conveying means and conveyed through the feed line into the line.

3. Method according to claim 1, further comprising conveying the milk out of the container and the flavor liquid out of the respective container by the pump and/or the flavor liquid by the conveying means in the line in each case in a controlled manner with a quantity portion which is determined.

4. Method according to claim 1, further comprising conveying multiple flavor liquids in each case out of a container optionally through the one feed line, or through a separate feed line in each case, into the line.

5. Method according to claim 1, further comprising conveying the milk or the foamed milk produced in each case with or without the flavor fluid, cold or heated, to the outlet, or that only at least one flavor liquid is conveyed without milk.

6. Appliance for carrying out the method according to claim 1, which is integrated in a coffee machine or in a separate milk unit, with at least one container, a line, a pump for sucking up the milk, an air feed line opening into the line for preparing foamed milk and a heating device for the milk, further comprising at least one feed appliance, with at least one feed line opens into the line for conveying milk, through which multiple flavor liquids are conveyed in each case from a container.

7. Appliance according to claim 6, wherein the feed line for the flavor liquid opens into the line for conveying the milk upstream of an inlet opening of the air feed line and upstream of the pump.

8. Appliance according to claim 6, wherein as a heating device, at least one steam line is provided, opening into the line for heating the milk or the foamed milk.

9. Appliance according to claim 6, wherein the feed line for the flavor liquid opens into the line upstream of the outlet and downstream of the at least one inlet opening of the steam line.

10. Appliance according to claim 6, wherein the containers comprise in each case a discharge line, each with a conveying means or a valve for opening or closing these lines.

11. Appliance according to claim 6, wherein the containers are arranged in a replaceable manner, such that, after emptying, they are replaced with new containers.
